(19) United States
(12) Patent Application Publication
(10) Pub. No.: US 2010/0148121 A1
(43) Pub. Date: Jun. 17, 2010

(54) REACTOR EMPLOYING CATALYSTS UPON OR WITHIN A CLOTH-LIKE MATERIAL

(75) Inventors: Kurt M. Vanden Bussche, Lake in the Hills, IL (US); Robert B. James, JR., Northbrook, IL (US); Alakananda Bhattacharyya, Glen Ellyn, IL (US); Manuela Serban, Glenview, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Morristown, NJ (US)

(21) Appl. No.: 12/555,352

(22) Filed: Sep. 8, 2009

Related U.S. Application Data
(60) Provisional application No. 61/138,153, filed on Dec. 17, 2008.

(51) Int. Cl. C01B 3/58; B01J 8/02

(52) U.S. Cl. 252/373; 422/211

(57) ABSTRACT

The present invention provides a reactor containing catalysts that are situated on or within a cloth like material which is either in a filter cake-like shape or a spiral wound reactor configuration. One application is the desulfurization of synthesis gas.

### CROSS-REFERENCE TO RELATED APPLICATION

This application claims priority from Provisional Application No. 61/138,153 filed Dec. 17, 2008, the contents of which are hereby incorporated by reference.

### BACKGROUND OF THE INVENTION

The present invention involves a process and a reactor that allows for the use of catalysts/adsorbents that are available in the form of a cloth or felt like substance. More specifically, this invention allows for the removal of sulfur and other impurities from gas at hot reaction temperatures. The reactor features low pressure drop, easy regeneration of the catalyst and a high volumetric density of the catalyst material (i.e. high m² of catalyst material/m³ of reactor).

Current commercial reactor designs are not making efficient use of active materials that are present in a cloth like embodiment. For instance, in the oxidation of NH₃ for the production of nitric acid, a Pt gauze is suspended in an empty vessel, acting as a catalyst for the reaction of ammonia with air. The vessel is mainly empty, containing a very limited amount of gauze per unit of reactor volume. In a second example, the use of catalytic cloths, which are suspended as strings, in a “string-reactor” has been suggested. This design again does not make effective use of vessel space.

The current invention shows the use of these “cloth” materials in two volumetrically more efficient embodiments. In a first embodiment, the cloth material is formed into a filter pad and placed in obstruction to the gas flow. The feed passes through one or multiple layers of the catalytic felt material, thereby contacting the catalytic or adsorptive sites, allowing the chemical or physical process to take place. In addition, with simple adjustment of the cloth porosity (e.g., the weave), one is able to adjust the filter pad porosity. In this way, the material can simultaneously act as a conventional filter, removing solids from the feedstock as it is undergoing the chemical or physical process. Regeneration of the bed is done advantageously with a solvent flow from the other direction, so as to remove the solids accumulated onto the filter pad and so as to regenerate the catalytic or adsorptive material with the highest efficiency.

A second embodiment, with an even higher volumetric efficiency, is one in which the cloth is spirally wound and enclosed into a cylindrical vessel. In this way, the cloth creates two distinct chambers in the vessel. One chamber is connected to the feed side of the vessel, the other side is connected to the exit side of the vessel. The fluid entering the vessel necessarily flows through the cloth like material, whereby it undergoes the desired chemical or physical process. Once it arrives in the second chamber, it flows to the exit, no longer obstructed. This embodiment features very high volumetric density of material and a low pressure drop, as each molecule of gas only sees a small amount of cloth. Indeed, in this design, the flux of the feed through the material (expressed in moles per m²/s) is very low, in view of the large surface area presented to the feed. As in the previous embodiment, regeneration can be done in the direction of the feed, or maybe advantageously, one may reverse the flow direction over the elements, to remove any solid material that may have accumulated against the cloth like barrier.

It is possible that the cloth material does not have sufficient physical strength to sustain the separation between the chambers (e.g. sagging or compression of the pad). In that case, one could consider using a stronger structure upon which the cloth is disposed (acting as a skeleton to ensure structural rigidity). This enhancement could apply to both embodiments disclosed above.

Either embodiment is advantageously operated in swing bed mode. In swing bed mode, two vessels are operated side by side, but are running in different phases of an operational cycle. Examples of an operational cycle, also known as a forced unsteady state regime, that occur commonly in the chemical processing industries would be adsorption/desorption (as in e.g., PSA, TSA) or reaction/regeneration (as in e.g., Fluid catalytic cracking). Periodically, the function of the parallel vessels would be altered, typically by flow switching. The time between two flow switches (semi-cycle time), is set by the time constant of the slowest of the two processes occurring in the parallel operations. If, for instance in the case of a adsorption/regeneration cycle, the kinetics of the regeneration are faster, the regenerated bed would be in hold mode until the bed in adsorption mode has become saturated. In some cases, there may be a need for a purge step between the two phases of operation, to, e.g., avoid contacting oxygen with a combustible gas, or to adjust the bed temperature. This extra step would be added on the side of the fastest process. If, e.g., the kinetics of the regeneration are again faster than that of the adsorption, one would execute the purge before the regeneration starts, upon flow switching from the adsorption phase.

The concept of a spiral wound embodiment for use in catalytic applications was disclosed by Pan in U.S. Pat. No. 5,916,531. However, Pan discloses this in the context of flow distribution into a catalyst bed that is disposed on the exit side of the module. As such, Pan teaches away from our invention, as we are disposing the active material unto the separation layer and are proposing the use of an empty zone on the exit side of the module, to ensure a low pressure drop.

The present invention comprises a reactor for treating a gas stream, wherein said reactor contains a support structure and a catalytic material deposited on said support structure, wherein the support structure comprises a metal oxide felt material. The metal oxide felt material can include ZrO₂, CeO₂, TiO₂, Nb₂O₅, Y₂O₃, B₂O₃, HfO₂, Al₂O₃, Al₂O₃-SiO₂, HfO₂-CeO₂, Yb₂O₃-CeO₂, Sm₂O₃-CeO₂, and mixtures thereof and solid solutions. A preferred metal oxide felt material is ZrO₂ and more preferably also contains yttrium.

The metal oxide felt material comprises layers having a thickness from about 0.25 to about 6.35 mm and preferably from about 1.27 to about 3.81 mm. The metal oxide felt material has a bulk porosity from about 50 to 100% and preferably from about 88 to 96%. The metal oxide felt material has a bulk density of about 128 to 1073 grams/liter and preferably from about 160 to 400 grams/liter. The metal oxide felt material has a melting point greater than about 1500° C. The catalytic material is selected from the group consisting of metals, metal oxides, metal sulfides, mixed metal oxides, mixed metal sulfides. The reactor may either be in a spiral wound structure or contain the support structure and catalyst material in a filter cake configuration within the reactor.

One of the applications considered for the present invention is the desulfurization of synthesis gas by means of an adsorbent that selectively removes H₂S and COS from the feed. Once the desired sulfur loading is reached, the material needs to be cleaned. In this regeneration step, the material is contacted with an oxygen or steam containing gas, removing the accumulated sulfur components, turning them into H₂S or SO₂.

For this application, one could consider, e.g., a swing bed version of a second embodiment, with two distinct phases of operation. In phase one, the sulfur containing synthesis gas flows through a first vessel containing a spiral element. H₂S and COS accumulate unto the felt like material and gradually fill up the available adsorption sites in the cloth. Simultaneously, the regenerant (air) is flowing through a second vessel containing a second spiral element, releasing the S components accumulated and converting them to SO₂. This is done in a “back flow” mode (the flow direction through the cloth is opposite to the feed flow direction for the regeneration), so as to achieve the most efficient regeneration (avoiding re-adsorption of the S species on the section of the cloth that had remained clean to avoid breakthrough). In addition, the application in question is somewhat likely to have suspended solids—fly ash—in the synthesis gas. Back flow regeneration would clean up any solid material that has accumulated against the cloth. At t=semi cycle time, the valves are switched and the functions of the first and second vessels is reversed, the system then operates in Phase 2 to complete the operational cycle.

1. A reactor for treating a gas stream, wherein said reactor contains a support structure and a catalytic material deposited on said support structure, wherein said support structure comprises a metal oxide cloth or felt material.

2. The reactor of claim 1 wherein said metal oxide cloth or felt material is selected from the group consisting of ZrO₂, CeO₂, TiO₂, Nb₂O₅, Y₂O₃, B₂O₃, HfO₂, Al₂O₃, Al₂O₃-SiO₂, HfO₂-CeO₂, Yb₂O₃-CeO₂, Sm₂O₃-CeO₂, and mixtures thereof and solid solutions.

3. The reactor of claim 2 wherein said metal oxide felt material is ZrO₂.

4. The reactor of claim 3 wherein said metal oxide felt material further comprises yttrium.

5. The reactor of claim 1 wherein said metal oxide felt material comprises layers having a thickness from about 0.25 to about 6.35 mm.

6. The reactor of claim 1 wherein said metal oxide felt material comprises layers having a thickness from about 1.27 to about 3.81 mm.

7. The reactor of claim 1 wherein said metal oxide felt material has a bulk porosity from about 50 to 99.9%.

8. The reactor of claim 1 wherein said metal oxide felt material has a bulk porosity from about 88 to 96%.

9. The reactor of claim 1 wherein said metal oxide felt material has a bulk density of about 128 to 1073 grams/liter.

10. The reactor of claim 1 wherein said metal oxide felt material has a bulk density of about 160 to 400 grams/liter.

11. The reactor of claim 1 wherein said metal oxide felt material has a melting point greater than 1500° C.

12. The reactor of claim 1 wherein said catalytic material is selected from the group consisting of metals, metal oxides, metal sulfides, mixed metal oxides, mixed metal sulfides.

13. The reactor of claim 1 wherein said support structure and said catalyst material are contained in a spiral wound structure.

14. The reactor of claim 1 wherein said support structure and said catalyst material are in a filter pad configuration within said reactor.

15. The reactor of claim 13 wherein said spiral wound structure further contains a rigid skeleton structure to which said support structure is attached.

16. The reactor of claim 14 wherein said spiral wound structure further contains a rigid skeleton structure to which said support structure is attached.

17. The reactor of claim 1 in which the gas stream comprises CO, H₂ and CO₂.

18. The reactor of claim 17 in which the treating comprises the removal of H₂S.

19. A process for the treatment or reaction of a gas stream, wherein said process employs a support structure and a catalytic material on said support structure, wherein said support structure comprises a metal oxide cloth material and in which at least 1 vessel is operated in a swing bed mode.

20. The process of claim 19 wherein said support structure and said catalyst material are contained in a spiral wound structure.

21. The process of claim 19 wherein said support structure and said catalyst material are contained in a filter pad like structure.
